(19) United States
(12) Patent Application Publication
(10) Pub. No.: US 2008/0040725 A1
(43) Pub. Date: Feb. 14, 2008

(54) Method and apparatus for a parallel model of tasks including abstracted execution and software development

(76) Inventor: Barrie Jon Moss, Cumbria, CA (US)

Correspondence Address: REED SMITH, LLP, TWO EMBARCADERO CENTER, SUITE 2000, SAN FRANCISCO, CA, 94111, US

(21) Appl. No.: 11/503,255

(22) Filed: Aug. 11, 2006

(51) Int. Cl. G06F 9/46

(52) U.S. Cl. 718/106

(57) ABSTRACT

Parallel processing is implemented by the deconstruction of a task into a set of dependency nodes in a dependency map. Brokers are used to dynamically identify and assign workers (processing units capable of performing work) to each of the nodes. Each node may be associated with a contract and/or a set of completion and initiation tasks each of which must be completed according to an appropriate schedule for synchronization and other parallel processing management issues. Each execution is performed on one or more processing devices that may be spread across a network and executed in conjunction with different devices and operating systems, including, portable devices running device independent operating systems.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to parallel processing of tasks, abstracted tasks, and software development.

2. Discussion of Background

Parallel processing is a form of information processing that exploits multiple processors in a programming environment using concurrent events. Concurrency implies parallelism, simultaneity and pipelining. Ideally, parallel events may occur in multiple resources during the same time instant. Parallel processing utilize concurrent execution of programs in the computer as a cost-effective means to improve system performance.

Various forms of parallel processing are utilized today. However, improvements in efficiency are needed to better take advantage of the parallel capabilities of the available and future hardware systems; for example multi-core processor assemblies and distributed device/processor networks.

### SUMMARY OF THE INVENTION

The present inventors have realized the need to increase efficiency in parallel systems and related software development. Roughly described, in one embodiment, the present invention provides a method of parallel execution of an activity, comprising the steps of, dividing an activity into a series of independent tasks, preparing a dependency map from the independent tasks comprising a series of dependency nodes each comprising a set of completion elements and a set of initiation elements, and executing each of the completion tasks to initiate execution of the initiation tasks in a manner determined by the dependency map.

In another embodiment, the present invention is a method of executing tasks in a dependency map, comprising, receiving a set of tasks linked by the dependency map, identifying a set of entities capable of performing a work function, and dynamically assigning the linked tasks to one or more of the set of entities.

In yet another embodiment, the present invention is a method a software development, comprising the steps of, abstracting a set of tasks into a set of nodes linked via a dependency map, adding descriptions to each of the nodes, analyzing and validating the dependency map and nodes, implementing the software development according to the validated dependencies.

The physical resource assembly is the set of physical resources available to do work. The physical resource assembly consists of a set of one or more physical and/or virtualised devices, in which each of the member devices contributes either the full set or a subset of its capabilities to the physical resource assembly.

The task set structured in the dependency map is then executed by a managing entity using the resources available in the physical resource assembly. The task set and the dependency map can be created independently of any general or specific physical resource assembly. This dynamic application of task set and dependency map to a physical resource assembly allows for the most efficient usage of the available physical resource assembly without binding the task set to a specific physical resource assembly at any point during the design, implementation and execution processes.

Portions of both the device and method may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a model of a parallel processing of an activity having an n element processing set according to an embodiment of the present invention;

FIG. 2A is an illustration of an example set of worker-broker relationships and description sets according to an embodiment of the present invention;

FIG. 2B is an illustration of a dynamic assignment is provided for one or more worker entities;

FIG. 3A is an illustration of a dependency map according to an embodiment of the present invention;

FIG. 3B is a physical resource assembly according to an embodiment of the present invention; and

FIG. 4 is a flow chart of a software development process according to an embodiment of the present invention.

### DESCRIPTION OF THE PREFERRED EMBODIMENTS

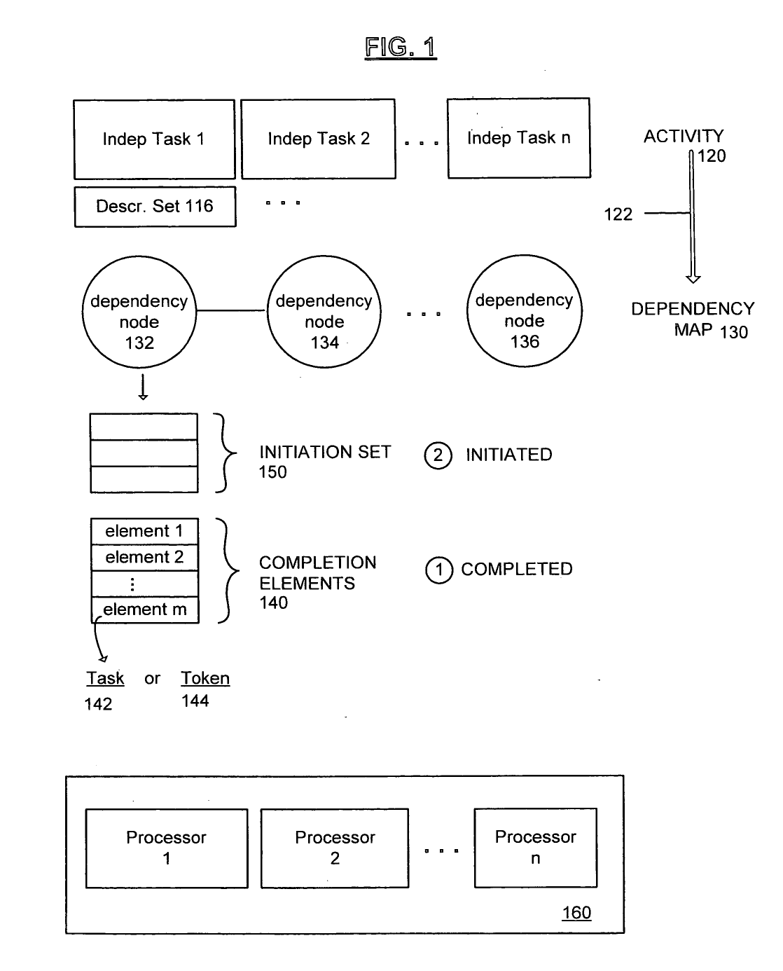

Referring now to the drawings, wherein like reference numerals designate identical or corresponding parts, and more particularly to FIG. 1 thereof, there is illustrated a model of a parallel processing of an activity having an n element processing set according to an embodiment of the present invention. As shown in FIG. 1, an activity 120 is deconstructed into a set of tasks within a dependency map 130, and abstracted for execution in a 1 . . . n processing element system 160.

The activity 120 is divided up into a series of independent tasks. For example, activity 120 is illustrated as comprising a series of independent tasks (e.g., Task 1, Task 2, . . . and Task n).

Each task is a unique and self contained piece of work. A task can have a description set, which is a description of the task, including but not limited to such things as purpose, author and nature of task (for example describing it as a graphic task). A descriptive set 110 is shown attached to Task 1.

The activity 120 assembles the tasks into a dependency map 130. The dependency map is a set of dependency nodes. For example, dependency map 130 is illustrated as comprising dependency node 1, dependency node 2, and dependency node n (denoting an n set of dependency nodes).

A dependency node includes a completion set 140 and a initiation set 150. An initiation set consists of one or more initiation elements. A dependency node requires all completion elements in the completion set to be moved to a status of completed (1) before the initiation elements move to a status of initiated (2).

The completion set 140 consists of one or more completion elements (e.g. elements 1, and 2 . . . m are illustrated). A completion element can be attached to any single instance of but not limited to a task or a token (e.g., Task 142 or Token 144).

A task that reaches termination can thus feed into a completion element and set it to a completed status. A token could be something such as, but not limited to, a message, a resource instance, a data structure or a signal. Any of these being set can lead to its completion element being set to a completed status.

A completion set can be associated with a contract. A completion contract can specify a set of requirements for the completion set (represented in FIG. 1 by completion elements). This can include but is not limited to a certain number of the completion elements being completed and a probability/potential trigger for the completion set (for example, allowing the simulation of neuron firing or completing a rule in a rule-based system).

An initiation set can also be associated with a contract. For example, an initiation contract may specify a set of requirements for the initiation set (represented in FIG. 1 by the initiation set). This can include, but is not limited to, the order in which initiation elements are initiated and a timing provision, which states that all tasks must synchronize and/or complete to a specific timer. An initiation element can be attached to any single instance of but not limited to a task or a token.

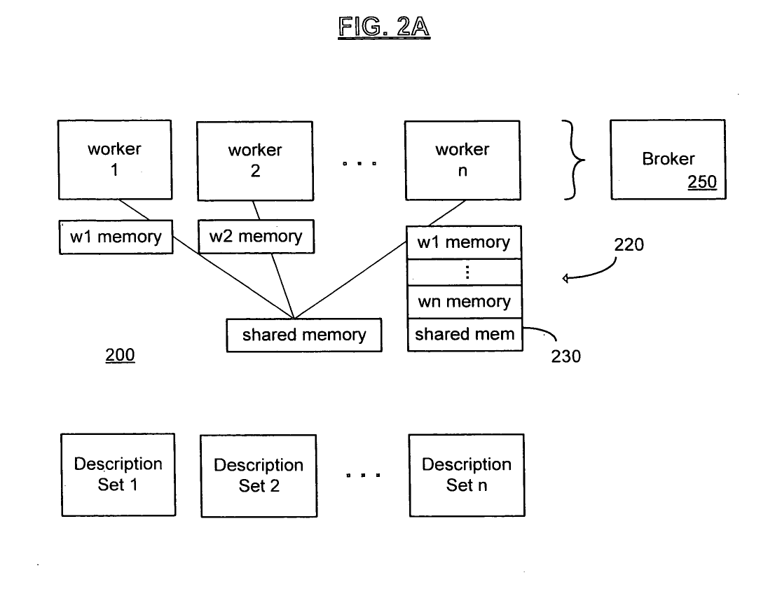

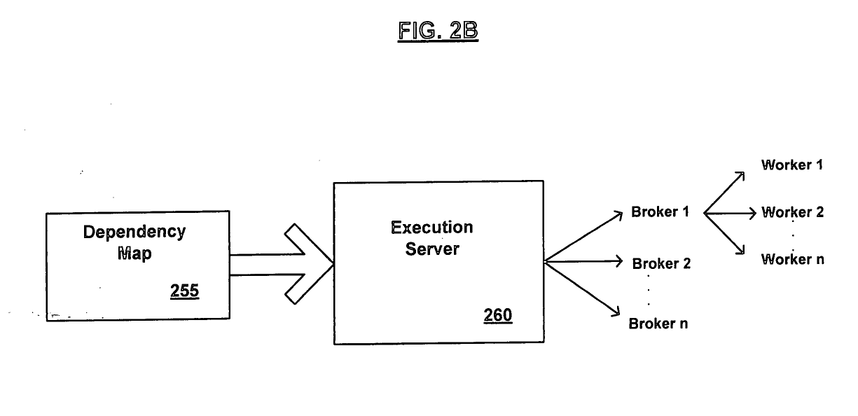

FIG. 2A is an illustration of an example set of worker-broker relationships and description sets according to an embodiment of the present invention. A system 200 provides a set of one or more workers (e.g. workers 1 . . . n). A worker is an entity that is able to do work. For example, the ability to do work may include but is not limited to a general purpose processing unit, a floating point processing unit, a graphics processing unit, and/or an MPEG2 decoder.

As shown in FIG. 2A, each worker can have its own dedicated memory (e.g. W1 memory dedicated to worker 4) and/or memory that is shared between other workers (e.g., shared memory 210, or, alternatively a shared portion 230 of a shared memory 220). Each worker is also shown as having a description set (e.g., Description set 1 corresponding to worker 1), which is a description of the worker, including but not limited to such things as type of worker, rate of work and unique resources and services.

A system 200 can be implemented in a single physical device or can be distributed across one or more physical devices. The physical devices may be networked locally, over the Internet, or by one or more wireless networks. Workers on a single device are abstracted and managed by a single broker (e.g. Broker 250). Brokers are able to communicate with each other and work together, creating a dynamic matrix of devices.

FIG. 2B is an illustration of a dynamic assignment is provided for one or more worker entities, allowing for the hosting of an activity dependency map. An execution service 260 is responsible for the execution of the dependency map of an activity (e.g. Dependency map 255). The execution service 260 communicates with one or more local device broker(s) to determine a set of available workers. This can include both local and remote workers.

The execution service 260 matches the dependency map 255 of the activity to the available worker set. In doing so it takes into account such things as but not limited to type of task, type of worker, time it will take a worker to perform a given task (or cost), task requirements, initialization and completion contracts, and loading upon the available worker set from other activities.

Time for a worker to perform a given task is dependent on such things as rate of work and initialization/termination of the task. Initialization and termination of a task is particularly relevant to remote workers as it may involve transfer of resources and services across a communications channel, which will have an impact on overall task completion.

The execution of an activity dependency map is dynamically applied to the available worker set in existence at that point in time. The activity can thus run equally on a single processor device, a multi-core device or a device matrix without the activity having to be aware of its eventual execution.

Most current software development is done in a procedural manner. Multi-core aware software usually requires a separate build with a multi-core aware compiler. The present invention includes a solution that utilizes an abstraction of software development from the eventual execution host or environment.

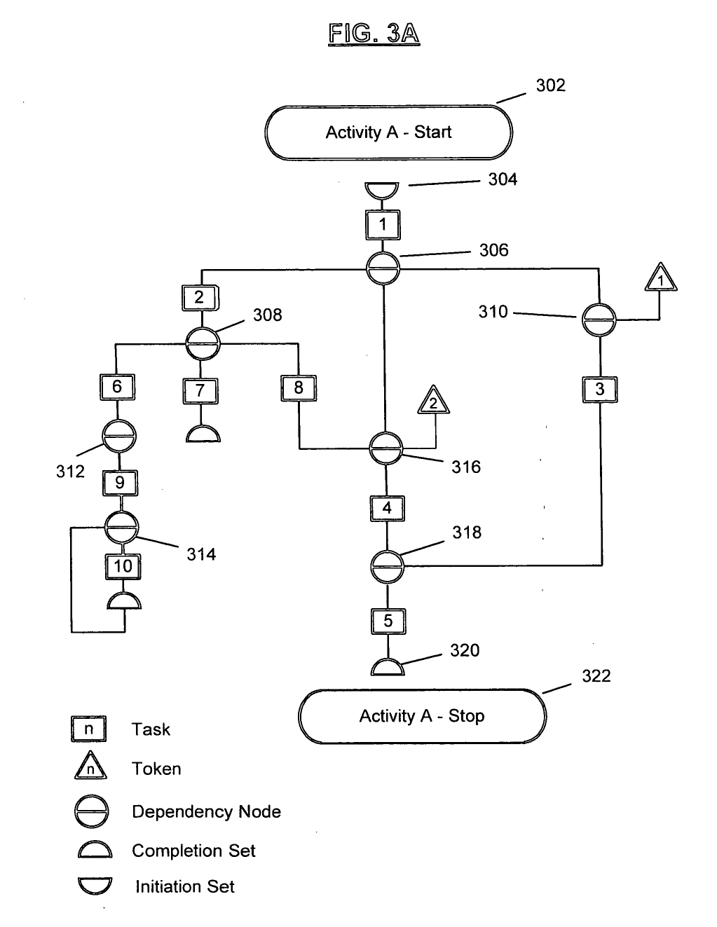

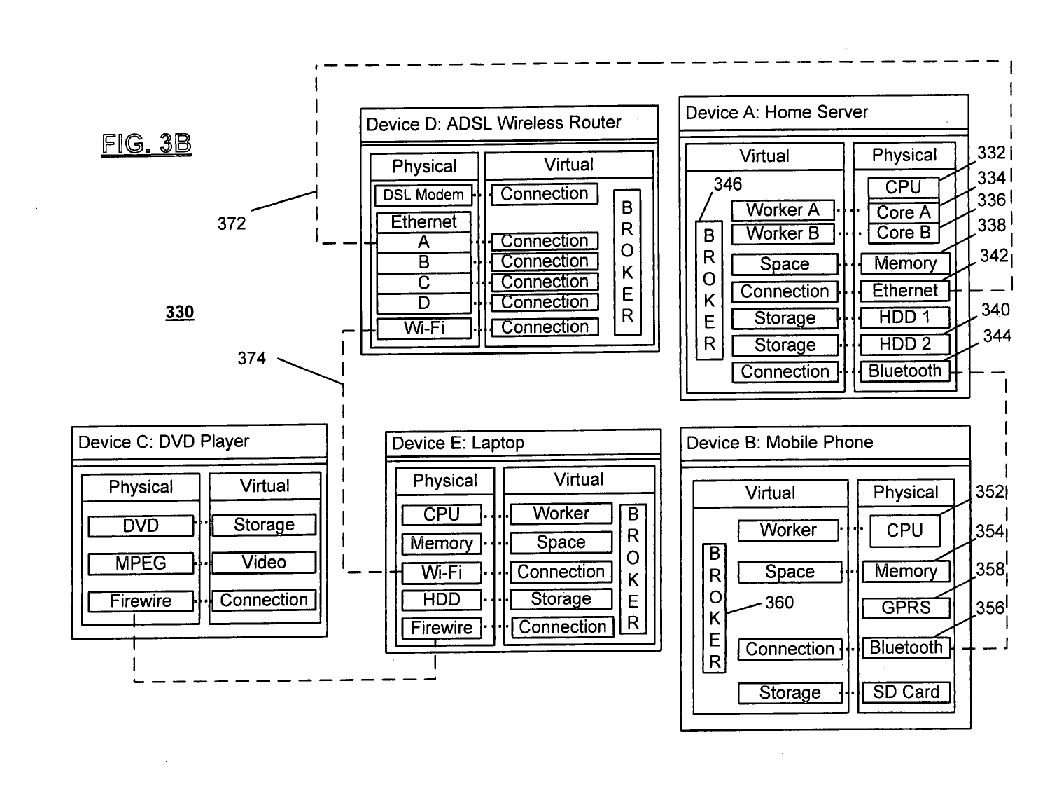

FIG. 3A is an illustration of a dependency map 300 according to an embodiment of the present invention. The dependency map 300 is an example of a model for software development.

Software development is abstracted to an activity as a set of tasks, built on the framework of the dependency map. Using a graphical representation, the activity is moved from a design document to a set of tasks arranged within a dependency map. For example tasks 1 . . . n (1 . . . 10) are illustrated in the dependency map 300. Initiation set 304, completion set 320, and dependency nodes (e.g., dependency nodes 306-318), and tokens (e.g., tokens 1, 2) are arranged between the activity start 302 and activity stop 322.

For example, software development is arranged as a set of tasks 1 . . . n. Initialization and completion sets are then added, along with any associated contracts. Description sets are added for any tasks requiring them. At this stage, the activity is platform and language neutral. Dependency, Loading and Flow analysis simulations can be run. When the activity has been validated, the tasks themselves can then be moved to an implementation stage, with coding and testing to one or more specific languages and/or platforms.

FIG. 3B is an illustration of physical resource assembly 330 according to an embodiment of the present invention. As shown in FIG. 3B, a series of devices, each including physical and virtual portions, are linked, and brokers are utilized as described above. For example, Device A represents a home server that includes physical asset or components of, for example, a CPU 332, core A 334 and core B 336, memory 338, Hard Disk Drive (HDD) 340, Ethernet 342, and Bluetooth 344. For each physical asset, a corresponding virtual component is shown by a dotted line from the physical side of the device into the virtual side. The virtual side includes a broker (e.g., Broker 346) and performs broker allocation/assignments as described above.

Device B represents a mobile phone with physical assets of, for example, a CPU 352, memory 354, bluetooth 356, GPRS 358, etc, and broker 360 on Device B's virtual side. The link is shown as a dashed line 365 between the bluetooth physical asset 344 of Device A and the bluetooth physical asset 356 of Device B. Other links, in this example, include Ethernet to Ethernet links (e.g., 372), and Wi-Fi to Wi-Fi links (e.g., 374) between different devices.

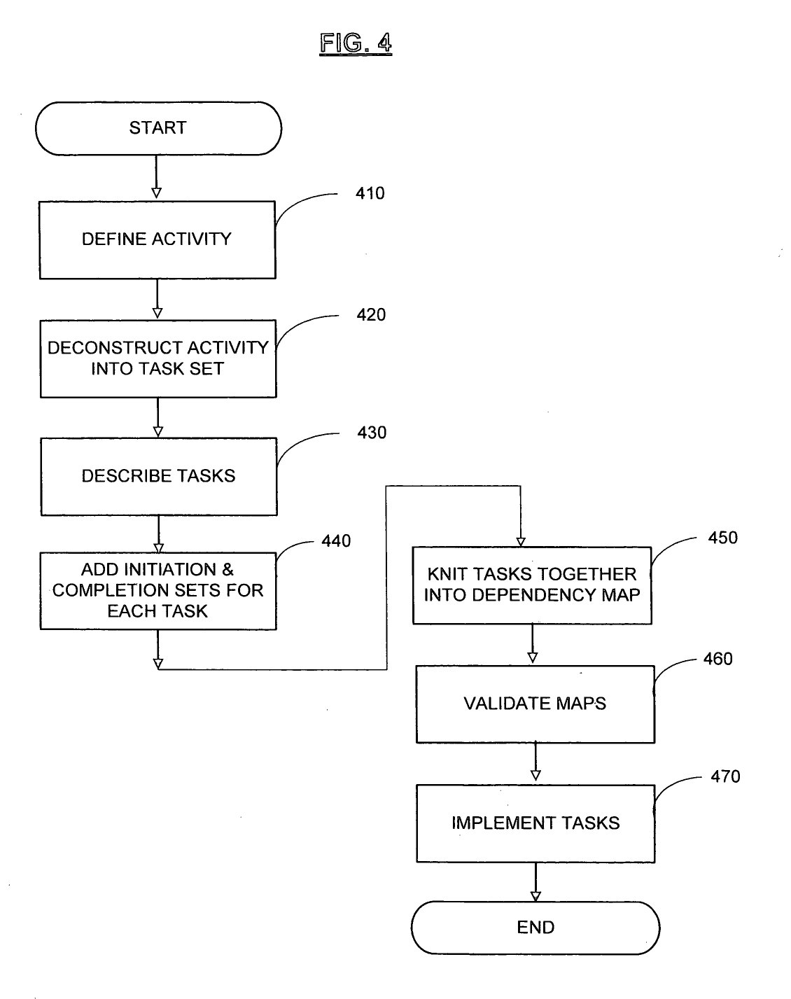

The process is illustrated in FIG. 4 which is a flow chart of a software development process according to an embodiment of the present invention. At step 410, a software project is abstracted to a dependency map (e.g. dependency map 300). Descriptions sets are added (step 420), and then analysis (step 430), including dependency, loading, and flow analyses are performed. Validation (step 440) assures a valid dependency and tractibility. Finally, the validated design and dependency are implemented (step 450).

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing broker, any other equivalent device, such as a preferred list, or assignment mechanism, or any other device having an equivalent function or capability, whether or not listed herein, may be substituted therewith. Furthermore, the inventor recognizes that newly developed technologies not now known may also be substituted for the described parts and still not depart from the scope of the present invention. All other described items, including, but not limited to maps, validations, contracts, sets, tasks, and/or tokens, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW+/−, micro-drive, and magneto-optical disks, ROMs, RAMS, EPROMs, EEPROMs, DRAMs, VRAMS, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above. In one embodiment, at least one of the independent tasks, initiation tasks, and completion tasks described above, or target of the software development is intended for execution or to be hosted on a device independent operating system. For example, any of the above may be executed on and in conjunction with a processor hosting the Amiga Anywhere™ operating system.

Included in the programming (software) of the general/specialized computer or microprocessor are software modules for implementing the teachings of the present invention, including, but not limited to, task identification, dependency mapping, rule implementation, initiation and completion sets execution and/or monitoring, identifying or attaching description sets, performing validations, and the display, storage, or communication of results according to the processes of the present invention.

The present invention may suitably comprise, consist of, or consist essentially of, any of element (the various parts or features of the invention) and their equivalents. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A method of parallel execution of an activity, comprising the steps of:
dividing an activity into a series of independent tasks;
preparing a dependency map from the independent tasks comprising a series of dependency nodes each comprising a set of completion elements and a set of initiation elements; and
executing each of the completion tasks to initiate execution of the initiation tasks in a manner determined by the dependency map.

2. The method according to claim 1, wherein the dependency map comprises an initiation contract that specifies requirements for the initiation set.

3. The method according to claim 2, wherein the requirements for the initiation set comprise an order in which the initiation elements are initiated and a timing provision that specifies a synchronization required of the initiation contract.

4. The method according to claim 3, wherein at least one of the initiation elements is attached to a single instance of a task or a token.

5. The method according to claim 1, wherein:
said method is embodied in a set of computer instructions stored on a computer readable media;
said computer instructions, when loaded into a computer, cause the computer to perform the steps of said method.

6. The method according to claim 5, wherein said computer instruction are compiled computer instructions stored as an executable program on said computer readable media.

7. The method according to claim 1, wherein at least one of the independent tasks, initiation tasks, and completion tasks are executed on a processing device hosting a device independent operating system.

8. The method according to claim 7, wherein the device independent operating system comprises an Amiga Anywhere™ operating system.

9. A method of executing tasks in a dependency map, comprising:
Receiving a set of tasks linked by the dependency map;
identifying a set of entities capable of performing a work function; and
dynamically assigning the linked tasks to one or more of the set of entities.

10. The method according to claim 9, wherein the step of identifying is performed by a set of one or more brokers that determine what entities capable of performing work are available at the time the dependency map will be executed.

11. The method according to claim 10, wherein the executions are performed in a parallel processing environment.

12. The method according to claim 10, wherein the executions are performed in parallel in different devices coupled via a network environment.

13. The method according to claim 10, wherein at least one of the entities is a device utilizing a device portable operating system.

14. The method according to claim 13, wherein the device portable operating system is an Amiga Anywhere™ Operation System.

15. A method a software development, comprising the steps of:
abstracting a set of tasks into a set of nodes linked via a dependency map;
adding descriptions to each of the nodes;
analyzing and validating the dependency map and nodes;
implementing the software development according to the validated dependencies.

16. The method according to claim 15, wherein:
the step of adding descriptions includes the steps of,
identifying completion elements to be attached to each node, and
identifying an initiation set to be added to each of the nodes; and
the completion elements are intended to be executed as a precursor to execution of the initiation elements.

17. The method according to claim 15, wherein the software development targets at least one software execution on a device independent operating system.

18. The method according to claim 15, wherein the software development targets the Amiga Anywhere™ operating system.

19. The method according to claim 15, wherein the steps of the method are embodied in computer readable code, compiled, and stored on a computer readable media.
